(19) United States
(12) Patent Application Publication
(10) Pub. No.: US 2025/0293921 A1
(43) Pub. Date: Sep. 18, 2025

(54) ROOT CAUSATION FOR NETWORK OPERATIONS

(71) Applicant: Selector Software, Inc., Santa Clara, CA (US)

(72) Inventors: Surya Chandra Sekhar Nimmagadda, Santa Clara, CA (US); Kannan Kothandaraman, Santa Clara, CA (US); Max Abishev, Santa Clara, CA (US); Vikram Rautela, Santa Clara, CA (US)

(21) Appl. No.: 18/604,815

(22) Filed: Mar. 14, 2024

(51) Int. Cl. H04L 41/069; H04L 41/0631

(52) U.S. Cl. CPC H04L 41/069; H04L 41/0631

(57) ABSTRACT

Systems, apparatuses, and methods for root cause analysis of a computing network are disclosed. A network management system builds a causation model based on causal mappings corresponding to network events. The causal mapping identifies a logical order of occurrence between a given network event and other network events. Network event obtained from the computing network is analyzed using the causation model for performing a root cause analysis for the computing network by generating a network event graph defining a one-to-one relationship between a given network event and one or more other network events. The causation model is built using determined hierarchical relationship of network events with a plurality of network entities as connected within the computing network.

### BACKGROUND

### Description of the Related Art

Monitoring a network involves observing the operational status and connectivity of entities within a computer network. Network monitoring systems empower network administrators to address issues promptly, whether it's a failure in a network entity or a degraded transmission performance in a connecting link. Typically, these systems comprise configured monitors that process signals to detect various network failure events. When a failure event is identified, the network monitoring system can generate data, such as alerts, notifications, and activate redundant failover systems to rectify the observed problem.

Failures in a specific network entity or connecting links can have downstream consequences for linked entities or links. Determining the root cause of a network failure event is crucial for understanding its nature and origin, allowing for proactive measures to be taken to ensure the network's intended operation. The contemporary scale and complexity of network systems present a challenging data analytics problem in real-time, especially considering the interdependencies among millions of entities across different sub-networks, layers, and domains.

In view of the above, improved systems and methods for root cause analysis of network failures are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram illustrating an implementation of a network management system.

FIG. 2 is a block diagram illustrating an implementation of various units of the network management system.

FIG. 3 is a block diagram illustrating root cause analysis of network even data.

FIG. 4 illustrates a block diagram of an example root cause analysis for network failures in an Open System Interconnection (OSI) based network.

FIG. 5 illustrates a method for root cause analysis of a network failure in network-connected entities under surveillance.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

In one or more implementations, when network events occur in a network, root cause analysis for a network failure or error can be traditionally performed using timestamps associated with each network event. For instance, based on the timestamps, it can be determined which network event occurred first and what network events occurred subsequently. The network event that occurred first can be marked as the root cause, and the subsequent network events are then handled as stemming from the determined root cause event. However, this can prove to be an inaccurate method of performing a root cause analysis, as these timestamps can be often imprecise owing to timestamp dampening. Timestamp dampening is used in network management systems to avoid flooding the system with a large number of events that might be triggered by temporary or transient conditions. Further, another issue with the traditional root causing of network events is that this analysis is not “network aware.” That is, the root cause analysis is not performed while considering different network events and their relationships with various network entities (e.g., how network entities are connected within different network layers of the network). Therefore, techniques for “network-aware” causation to perform root cause analysis of network events are needed.

Systems, apparatuses, and methods for “network-aware” causation to perform root cause analysis of network events. Firstly, network events occurring in a network are filtered based on filter criteria, in order to determine whether these network events are correlated. This filtering is done based on temporal proximity of the events. The filtered events are translated into vector embeddings, which is done based on network-based metadata, so as to correlate similar vector embeddings. Since vector embeddings are generated using network-based metadata, this enables correlating events that signify the type and network-specific tags. The embedded vector representations are then compared for similarity. Vectors with similarities are correlated and the correlated vectors represent correlated network events. These correlated events are then processed through a causation model. The causation model utilizes outputs from a network hierarchy model that is pretrained on network hierarchies such that when correlated events are processed using the model, root causation is accurately performed in light of various network interconnections. Further, the causation model can be configured and modified based on new network types dictated by an end-user.

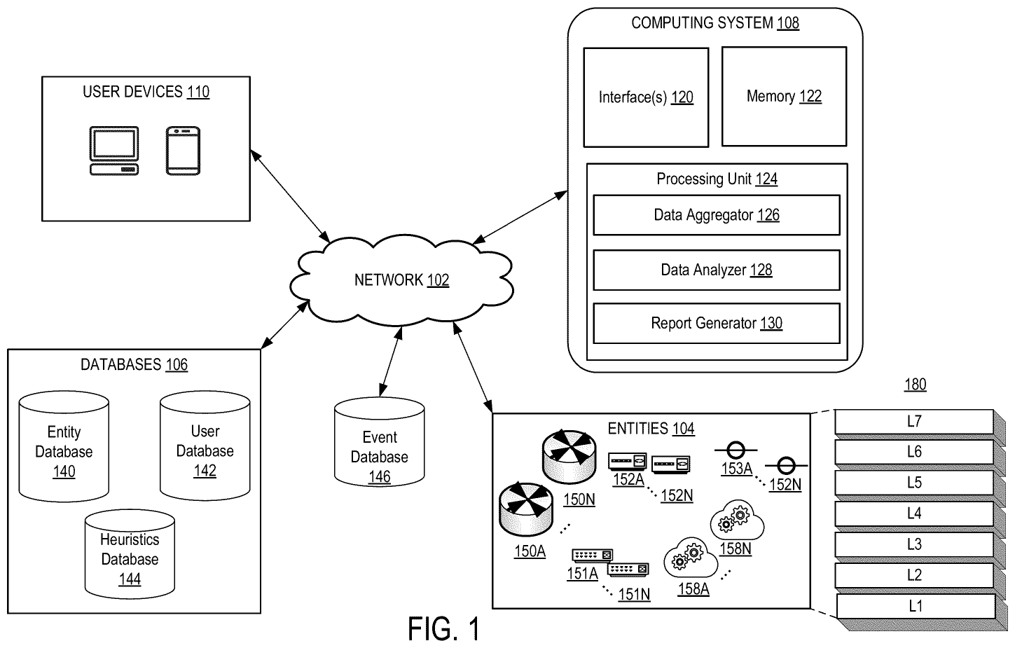

FIG. 1 illustrates an exemplary network implementation 100 for functioning of a computing system 108 (alternatively referred to as network management system or NMS 108). In an implementation, the network management system 108 is configured to manage network operations and maintenance of one or more entities 104, interconnected over a network 102. In one implementation, entities 104 managed by the network management system 108 can include one or more hardware units, e.g., routers 150A-N, switches 151A-N, repeaters 152A-N, and cables 153A-N. Further, the entities 104 can also include software entities 158A-N, e.g., ethernet drivers, socket APIs, one or more libraries, and other application software. In an implementation, other network equipment, such as computers, networks, and storage systems, can also be managed by the NMS 108. The entities 104 managed by the NMS 108 can be used to run important applications, services, and store critical data for businesses. As used hereinafter, “entity” is meant to include devices and/or services under surveillance by a network management system, until otherwise specified. The “entity” in the context of this disclosure can include one or more physical datacenters, software services, network devices, optical transceivers, various network interfaces, network links, routers, protocols, network sessions and other computing software and/or hardware infrastructure.

For instance, these entities can allow businesses to access and use resources, such as applications, development platforms, servers, storage, and virtual desktops, over the internet or a dedicated network. In one implementation, the entities 104 managed by the NMS 108 form part of an Open System Interconnection (OSI) model-based network 180. The OSI model is a conceptual framework used to standardize functions of a telecommunication or computing system. The OSI model defines a hierarchical structure comprising seven layers (e.g., layers L1-L7), each responsible for specific aspects of network communication. These layers serve as a reference model for understanding how data flows between devices in a networked environment. Other types of networks can also be managed using the NMS 108.

The NMS 108 is configured to provide analysis of the workings of the entities 104 to one or more user devices 110 over the network 102 (e.g., such as Internet). In one example, the user devices 110 include devices used by IT administrators, network engineers, and/or maintenance personnel to inspect performance of the services 104, either on-site or remotely. User devices 110 can include personal computers, digital assistants, smartphones, tablets, and laptops, can be connected to the network 102 or operate independently. These devices may also have various external or internal components, like a mouse, keyboard, or display. User devices 110 can run a variety of applications, such as word processing, email, and internet browsing, and can be compatible with different operating systems like Windows or Linux.

In an implementation, the NMS 108 is configured to identify network events and associated anomalies with the network 180. For instance, the NMS 108 is designed to identify root causes behind network events and anomalies in the network 180, which may be a large, constantly changing, and diverse network. A ‘root cause’ signifies a fundamental failure that is linked to one or more observable network failure occurrences. These observed events are viewed as resulting network events of a root cause network event. For instance, an application running on a server in an application layer (L7) relies on a reliable connection established through transport layer (L4). The server further communicates with a database on a separate node. Now, if the layer L4 experiences a failure on the server side, such as a sudden termination of the established connection due to a network interruption or a software issue, the application running on layer L7 may be unable to communicate with the database server. The failure in the layer L4 disrupts the reliable data transfer between the two nodes. As a result, the application at the application Layer (L7) does not receive the expected responses from the database server, leading to errors or even a complete breakdown of the application functionality. In this scenario, the failure in one node (transport layer on the server) causes a failure in another node in a different layer (application Layer on the server) of the network 180.

In such scenarios, it is important for the NMS 108 to identify the root cause of the failure and resulting network events, i.e., failure quickly and efficiently in layer L4 leading to fault in the layer L7, to ensure that the application resumes functionality. In order to do so, the NMS 108 constantly stores and analyzes network event data for events occurring within the network 180. As described herein “event data” refers to the information generated by network devices and systems regarding events or activities occurring within a computer network (e.g., network 180). This data typically includes details such as the timing, source, destination, type, and characteristics of network events, such as packet transmissions, connections, errors, or security incidents. Network event data is crucial for monitoring, troubleshooting, analyzing performance, detecting anomalies, and ensuring the security and reliability of computer networks. In one implementation, this data is stored at an event database 146.

In one implementation, the NMS 108 is configured to gather network monitoring signals and pertinent operational events concerning network entity operation, e.g., maintenance schedules, event data, or log data from one or more data sources. The NSM 108 organizes these inputs into a standardized format of network events, which can be exported for additional analysis. These network events are filtered using temporal proximity, and filtered events are further analyzed. Further, supplementary information, such as network-specific metadata, is included with each event to aid in correlating these events with respective network entities as well as with network layers of the network 180. The NMS 108 is equipped with one or more components, that operate by processing these correlated events for deducing probable root causes. As used herein, “correlated network events” refer to a set of network-related events that are statistically associated or linked in some manner. These events demonstrate a relationship or dependency between them, indicating that the incidence of one event may influence or be influenced by the occurrence of another event. Correlated network events are analyzed to examine patterns or trends in network data to uncover relationships (e.g., cause and effect) between different network events or variables.

In an implementation, the NMS 108 processes the correlated events using a causation model. According to the implementation, the causation model is a machine learning model. A causation model uses machine learning to identify and quantify causal relationships between variables in a dataset. Unlike correlation, which only measures the strength of association between variables, the causation model is configured to identify the directionality and mechanisms underlying the relationships. In using the causation model for analyzing correlated events, the NMS 108 takes two inputs: the current causation model and the present set of correlated network events. The correlated network events are processed with respect to various nodes identified in the causation model. The causation model then outputs a directional network event graph that defines one-to-one relationships between a root network event and other network events stemming from the root network event.

In an implementation, real-time identification of root causes often involves the NMS 108 analyzing complex interconnections among numerous network entities, which may have different owners and operators. This analysis must occur promptly, without the need for post-processing of monitoring data, to determine the underlying reasons behind network failures. Given the dynamic nature of these networks, such as network 180, with entities being added or encountering faults regularly, the relationships among millions of network entities can be constantly evolving. While simply analyzing correlated events can offer some insights, deploying enough monitors to gather and process the necessary data for real-time root cause correlation in large-scale networks is impractical.

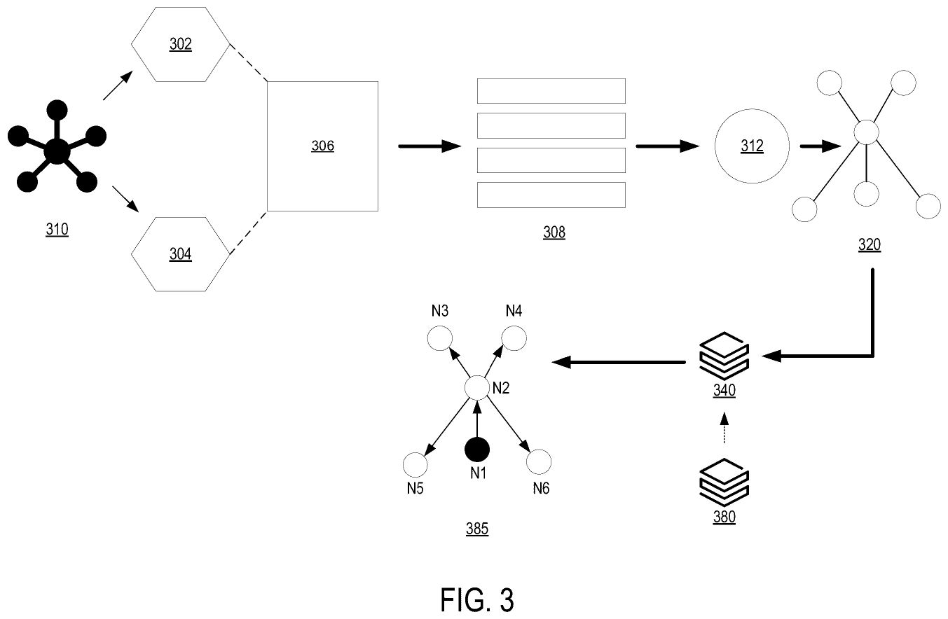

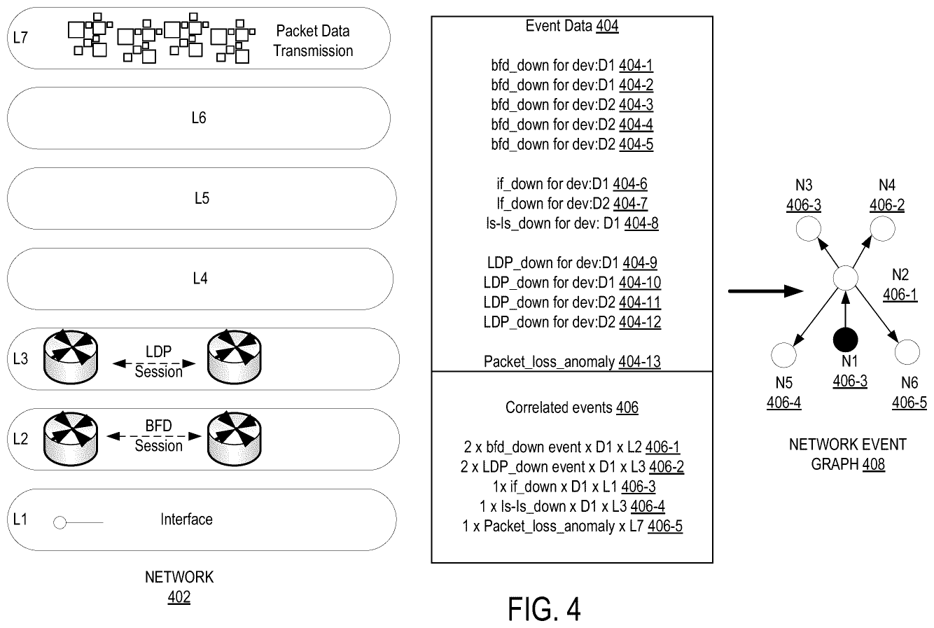

In one implementation, to process the correlated events in light of network interconnections of various entities 104 of the network 180, the causation model utilizes outputs from a pretrained network hierarchy model, that is built and trained based on information on interconnections between various network entities with different layers of the network 180. The network hierarchy model is trained by analyzing, for a predetermined period of time and/or number of instances, event data corresponding to network entities connected within network 180. This analysis includes, without limitation, correlating the event data for each entity with one or more network layers of the network, as gathered from the network topology (e.g., topology of the layers L1-L7). Based on this correlation, the data analyzer 128 ascertains a mapping of network events, comprising a logical order of multiple network events in a cause and effect relationship. Further, each of these network events are also associated with corresponding network layers of the network 180. That is, the network hierarchy model is not only trained on event data associated with network entities gathered over a period of time, but also on interconnections between different network entities operating within multiple layers of the network 180. Using outputs of the trained network-hierarchy model, the causation model can efficiently analyze network events in light of various network interconnections to perform root cause analysis for the network 180. These and other implementations are described in further detail with respect to FIGS. 3 and 4.

As shown in FIG. 1, the NMS 108 is further connected to one or more databases 106, over the network 102, such that data generated as a result of execution of instructions by the NMS 108, is stored in at least one of the databases 106. In one implementation, the databases 106 can be internal to the NMS 108. The databases 106 include an entity database 140, a user database 142, and a heuristics database 144. The entity database 140, in an implementation, can be used to store data associated with one or more of the network entities 104. The data can include business data, location data, equipment data, maintenance data, and the like for one or more entities 104. The user database 142, in an implementation, stores data associated with users of the user devices 110. The data can include user registration data, device-type data, designation data, organizational data, and the like. Further, heuristics database 144 can store data associated with policies and heuristics-based rules, that can be used by the NMS 108 to perform root cause analysis for network events for the network 180 (and/or other similar networks under surveillance).

The NMS 108 includes one or more interface(s) 120, a memory 122, and a processing unit 124. In an implementation, the one or more interface(s) are configured to display data generated as a result of the processing unit 124 executing one or more programming instructions stored in the memory 122. The processing unit 124 further includes data aggregator 126, data analyzer 128, and report generator 130. The data aggregator 126 is configured to collect data associated with one or more entities of the network entities 104, from a variety of data sources. In an implementation, the collected data is indicative of operational parameters of the entities 104 being monitored. The data, in an example, can include information pertaining to events, logs, performance metrics, and the like. In an implementation, the data is heterogenous, in that, the content as well as the format of the data is non-consistent. The data aggregator 126 is configured to ingest such heterogenous data from multiple data sources, such as, network management interface data, data services pipeline data, time-series data, and the like. The data can also include data from existing data logging and network monitoring systems. In an implementation, data from each different data source is collected by the data aggregator 126 using one or more data collection engines (not shown). The collected data is processed and can be stored by the data aggregator 126, e.g., in the entity database 140. It is noted that as used herein the terms “unit” or “engine” may refer to circuitry configured to perform the various disclosed functions. Such circuitry may be special purpose or general purpose circuitry configured to execute software that performs the various functions. In other implementations, the term unit or engine may refer to software (modules, libraries, etc.) specially designed to perform the various functions. Various such alternatives are possible and are contemplated.

The data analyzer 128 analyzes the collected data and provides an abstract view of the data, for example, by decoupling the data from its source. In an implementation, the abstract view of the data by decoupling of data can be facilitated by the use of virtual machines and/or containers. The decoupled data can then be normalized by the data analyzer 128 and redirected to specific storage repositories (not shown), created for each type of data. The decoupled and normalized data, in an implementation, is utilized by the data analyzer 128 to generate network-specific metadata (e.g., meta tags) corresponding to each category of data collected (e.g., network events, logs, alarms, warnings, errors, or other information) for inspection of one or more entities 104, in real-time or near-real time. In an implementation, the meta tags are generated in the form of labels, such that the collected data, when infused with these labels, can be cross-correlated to monitor each data category for the one or more entities 104.

As described in the foregoing, the ingested data at least includes network event data. In an implementation, the event data includes unstructured textual data blocks, such that each data block is processed by the data analyzer 128. For instance, the data analyzer 128 is configured to normalize each data block to identify one or more data patterns. The data analyzer 128 further generates a set of network-specific meta tags from the plurality of data blocks and associates each data block with a meta tag. In an implementation, data analyzer 128 utilizes network-specific parameters, for example, type of entity, type of event, corresponding network layers, etc., to infuse event data with network-specific metadata. Further, the data analyzer 128 creates a real-time network aware causation model, e.g., based on pretrained network hierarchy models, as well as user-defined heuristic data.

In an implementation, report generator 130 is configured to generate reports, e.g., including network event graphs, for display on one or more graphical user interfaces of the user devices 110. The network event graphs, in one implementation, present relationships between various network events corresponding to a given network, such that a network event can be identified as a probabilistic root cause for a network error. The report generator 130 can further provide the user devices 110 options to modify the generated event graphs, e.g., by using one or more user settings. These user settings can include policies and rules defined by the end-user, for example, based on these settings network events can be highlighted for further analysis or disregarded from the root cause analysis. If such settings are identified for a user device 110 is received, the report generator 130 can update the network event graph(s) in real-time.

In one implementation, the NMS 108 can be a standalone computing system. In another implementation, the NMS 108 can take form of a processing unit or circuitry of a computing system comprising of a central processing unit and a system memory. Such implementations are contemplated.

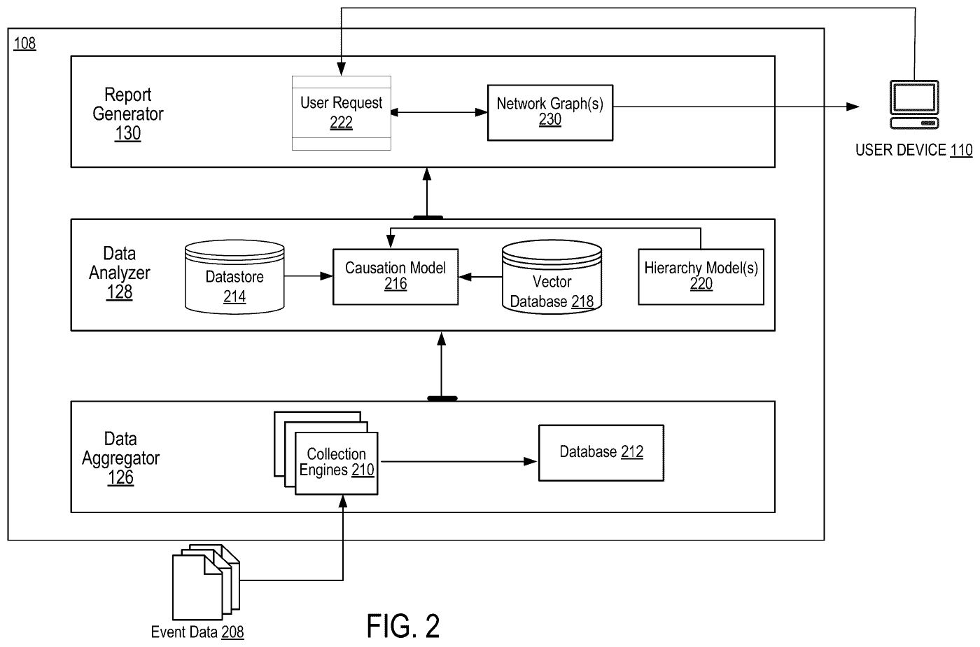

FIG. 2 illustrates an implementation of various units of the network management system. It is noted that one or more components of the network management system (NMS 200) are similar to components described in FIG. 1. These components have been called-out as such.

In one implementation depicted in the figure, one or more collection engines 210 collect retrieve or gather event data 208, e.g., from one or more networks under surveillance (network 180 described in FIG. 1). The event data 208 can be retrieved from event data sources (e.g., event database 146). These collection engines 210 are part of the data aggregator 126. In an implementation, the data aggregator 126 connects to existing inventory or Configuration Management Database (CMDB) tools associated with an entity being monitored. According to the implementation, the data 208 collected from such tools can include static inventory definitions from a file or dynamic definitions via an Application Programming Interface (API). The data aggregator 126 can also integrate with an existing instance of such a tool (e.g., Netbox instance, etc.) and/or provide inventory as a service using an internal Netbox instance (not shown).

The collected data 208, is used to create a database 212, such that data from the database 212 can be used by one or more components of the NMS 108 for real-time telemetry and enrichment. Further, each collection engine 210, in an implementation, can be cloud-native, such that scaling out of the collection engines 210 for new types of event data 208 is possible. The collection engines 210 are configured to provide an entry point for ingestion of data into the NMS 108. Different types of event data 208 ingested from the collection engines 210 can include network management interface data, data from data pipeline services, time series data, representational state transfer (REST API) data, monitoring tool data, and the like.

In an implementation, the event data 208 is collected in real-time or near real-time. For instance, the data is collected as it is generated or at regular intervals, such as every second, every 10 seconds, every 30 seconds, every minute, or every hour. The data aggregator 126 can organize the received event data 208 based on event type, event severity, event start time, event end time, and/or by one or more network entities linked to one or more network failure events identified within the event data 208.

The data analyzer 128 accesses the event data 208 produced by the collector engines 210, from the database 212. In an implementation, the data analyzer 128 is configured to use network-aware causation techniques for inference of underlying causes linked to network failure occurrences. “Network-aware” causation in the context of this disclosure includes the NMS 108 analyzing network event data based on a relationship between each detected network event to network entities. For instance, event data for each network event is processed in light of how network events for a given network occur, e.g., in what logical order, with respect to different network entities (e.g., network equipment, network protocols, software applications, etc.). In one non-limiting example, the relationship is defined on the basis of different layers of the network, e.g., layers of an OSI network. In another example, the NMS 108 implements event correlation techniques, as described in detail herein, to identify patterns between different network events and network entities. This aids in detecting root causes for anomalies, as well as for predicting future network events, thereby improving network management. Further, as network environments are dynamic, the NMS 108 continuously monitors, analyzes, and refines the relationships between network events and entities. For instance, network hierarchies can be updated based on user inputs and/or changes in network entities.

In one such implementation, the data analyzer 128 is configured to generate a network-aware causation model using the event data as well as one or more pretrained network hierarchy models 220 as input parameters. In an implementation, the data analyzer 128 is configured to generate and pretrain a network hierarchy model based on type of networks managed by the NMS 108. In one non-limiting example, the network hierarchy model is constructed for an OSI network, e.g., network 180 of FIG. 1. The network hierarchy model is trained by analyzing, for a predetermined period of time, event data 208 for entities connected within the OSI network. This analysis includes, without limitation, correlating the event data 208 for each network entity with different network layers of the network, as gathered from the network topology of the network. In one example, the correlation can be done using one or more of neural networks, decision trees, graph-based models, etc. Based on this correlation, the data analyzer 128 can ascertain a mapping of network events (identified from event data 208), e.g., comprising a logical order of multiple network events in a cause and effect relationship. Further, each of these network events are also associated with corresponding network layers of the network. That is, the network hierarchy model is not only trained on interconnections between different network entities operating within multiple layers of the network, but also on event data associated with these network entities gathered over a period of time. Using the network hierarchy model, a network-aware causation model (“causation model 216”) is generated, such that the causation model 216 can identify sequential mappings between network events as these occur in different network layers of the OSI network. The causation model 216 can perform real-time root causation between correlated events as indicated by event data 208 received continually by the NMS 108.

In one or more implementations, the network hierarchy model can be retrained (or additionally trained) on heuristics or policy-based user configurations, e.g., as defined by specific end-users. In such an implementation, the hierarchy model can be trained on domain-specific rules or guidelines dictated by the user. According to the implementation, the heuristics representing important domain knowledge can include if-then rules, mathematical constraints, logical conditions, or any other guidelines specific to a given domain or user. In order to train the network hierarchy model, the heuristics are integrated directly into the model architecture or training process. This involves creating custom loss functions, regularization terms, or constraints that enforce adherence to the heuristics. The model is then retrained on the event data 208 for a given period of time and/or number of instances, while enforcing the user-defined heuristics. The training process is adjusted as necessary to ensure that the model learns to follow the heuristics effectively. Finally, the retrained model is validated using appropriate evaluation metrics to ensure that the model performs well not only in terms of traditional network hierarchy, but also in terms of the user-defined heuristics. In an implementation, the network hierarchy model can be retrained each time new user-defined heuristics are received. These heuristics can include, without limitation, user configuration data, new event types, override settings, and the like.

During network management operations, the data analyzer 128 accesses processed event data 208 associated with a given network, e.g., from the database 212 and stores this data locally in a datastore 214. In an implementation, the data analyzer 128 performs one or more operations on the data 208 before it is processed by the causation model 216, e.g., for root cause analysis of network failures within the given network. For example, the event data 208 representing anomalies and network events associated with the network is first filtered using temporal proximity. In one implementation, to filter the event data 208 using temporal proximity, the data analyzer 128 may disregard an order of timestamps of individual anomaly or event, but rather consider a preset window of time to filter the network events data 208. This is done as event timestamps can be often inaccurate owing to timestamp dampening which may be used to prevent excessive or unnecessary event generation by introducing a delay or dampening factor in the reporting of network events.

In one implementation, the data analyzer 128 then translates the filtered network events into network operations aware embeddings. As used herein, “network operations aware embeddings” (hereinafter interchangeably referred to as “vector embeddings” or “embedded vector representations”) refer to a technique to integrate network operational information, such as network-specific metadata, into vector embedding representations of network events. In the context of this disclosure, vector embeddings are enriched with operational context or metadata related to network behavior, performance metrics, configuration details, or other relevant operational aspects. This integration is performed to enable the vector embeddings to capture not only the inherent structural relationships within the network but also its dynamic operational characteristics. By using network metadata to create vector embeddings, these can be better analyzed by causation model 216, e.g., based on an operational context of the network. In one example, the operational context is given by network-specific meta tags that signify the type of network event, e.g., a Bidirectional Forwarding Detection (BFD) session established between two routers for the purpose of monitoring the connectivity and forwarding path between them using the BFD protocol. In an implementation, other metadata tags such as location, etc. may be disregarded.

In one example, the embedded vector representations are stored in vector database 218. The data analyzer 128 can then perform a comparison of embedded vector representations for similarity. The comparisons can be performed using one or more methods such as cosine similarity, Euclidean distance, Jaccard similarity index, and the like. Network events corresponding to similar vectors are considered as correlated network events. In an implementation, correlated network events represent a highly significant set of network events within the overall pool of events associated with a given network. The correlated events (represented by correlated vectors) are processed through the causation model 216. The data analyzer 128 processes the correlated network events using the causation model 216 to identify a root cause corresponding to one or more network errors or anomalies. In one implementation, based on the processed events, the causation model 216 generates a network event graph 230 identifying a root cause network event for the network error and one or more other network events in one-to-one intermediate and one-to-one final relationships. Using this approach, the data analyzer 128 can identify a small set of correlated events and identify cause and effect relationships within that set of events, from an incoming large set of network events. The network event graphs 230, in one implementation, present relationships between various root causes associated with a network failure and corresponding network events resulting from each root cause. An exemplary network graph event, generated in response to analyzing network events, is described in FIG. 4.

In an implementation, the network event graphs 230 can be presented by report generator 130 to be displayed on a graphical user interface (GUI) of a requesting user device 110, e.g., in response to one or more user requests 222. The report generator 130 can further provide options to modify the generated graphs, e.g., based on one or more user settings. These user settings can include preferences defined by the end-user, such that based on these settings selected network events can be highlighted for further analysis, disregarded from the root cause analysis, or event data for these events are otherwise modified. If such a preference is found associated with a user, the report generator 130 can update the network graph(s) in real-time. The generation and presentation of network event graphs is further detailed with respect to FIG. 3.

FIG. 3 is a block diagram illustrating root cause analysis for network events using network even data. As described in the foregoing, network event data is received from a given computing network, by a network management system, to perform a root cause analysis of one or more network failures in real time or near real time. The network management system performs the root cause analysis using a network hierarchy aware causation model. In operation, data associated with various network events (network event data 302) as well as anomalous network entities (anomaly data 304) is received from a network 310 under surveillance. Other data such as log data, warning data, alarm data, etc. can also be collected. In an implementation, network event data 302 includes source and destination internet protocol (IP) addresses, associated protocols, actions taken, event description or summary, number of bytes transmitted, and the like. In an example, event data 302 for any given network event can have the following exemplary format:
Timestamp: 2024-02-08 14:35:21
Source IP: 192.168.1.10
Destination IP: 8.8.8.8
Protocol: UDP
Bytes Sent: 1500
Bytes Received: 1200
Action: Allowed
Description: DNS query initiated from local network to Google's DNS server (8.8.8.8) for resolving www.example.com.

Further, anomaly data 304 can include information indicating deviations or irregularities from expected patterns or behaviors of network entities within the network 310. These anomalies can signify potential security threats, operational issues, or abnormal activities that require investigation and remediation. An exemplary format of network anomaly data 304 is as shown below:
Timestamp: 2024-02-08 12:45:03
Source IP: 192.168.1.20
Destination IP: 104.27.150.98
Protocol: TCP
Bytes Sent: 800
Bytes Received: 0
Action: Blocked
Description: Unusual outbound TCP connection attempt from an internal IP to an unfamiliar external IP address. Blocked due to suspicion of potential threat.

In an implementation, the network management system is configured to collect event data 302 and anomaly data 304 from the network 310 over a certain period of time, such that enough data is accumulated for analysis of any faults or malfunctions occurring within the network 310. During this period of time, the event data 302 and anomaly data 304 undergoes various processing operations, to ascertain a root cause of one or more network failures. That is, from the data collected for various network events and anomalies, the system is configured to identify a potential root cause when for a given network failure, and one or more correlated events (or anomalies) can be identified as stemming from the root cause network event. In one implementation, the root cause analysis is performed in real-time or near real-time. It is noted that each process for root causation of network failures is similarly performed using both the event data 302 as well as anomaly data 304, however, for the sake of simplicity the discussion that follows only describes the processes as applied to the event data 302. The techniques described herein apply to the anomaly data 304 as well.

In one implementation, the first process applied to the collected event data 302 is filtering the event data 302 by temporal proximity. Traditionally, a root cause analysis is performed simply using a timestamp associated with each network event. For instance, based on the timestamps, it can be determined which network event occurred first and which network events followed. The first network event can be marked as the root cause, and the subsequent network events are then handled as stemming from the determined root cause. However, this is can be an imprecise method of performing a root cause analysis, as these timestamps can be often inaccurate owing to timestamp dampening. Timestamp dampening is commonly used in network management systems to avoid flooding the system with a large number of events that might be triggered by temporary or transient conditions.

In order to provide for precise analysis, the methods described herein filter the event data 302 based on their temporal proximity and not merely on timestamp data. In one implementation, attributes of event data 302 are compared with one or more filter criteria, so as to determine whether events corresponding to the event data 302 can be grouped together. For instance, the attributes can include a preset time period window, recurring pattern thresholds, a sequence of event data 302 arrival at the system, and the like. For example, if a given set of network events occur within a given time period dictated by the filter criteria (e.g., 5 minutes), these can be grouped together. In one example, the system disregards the order of the timestamps of individual event, and only considers the window of time to filter events. In another example, if a number of recurrences of two or more events exceeds a threshold number given by the filter criteria, these events can be grouped as well. Other implementations are contemplated.

Once potentially correlated network events are filtered and grouped, a network operation enrichment process 306 is performed. In one implementation, during the network operation enrichment process 306, the event data 302 of filtered events is enriched with network-specific metadata associated with the network 310. For example, the system generates, for each network event, a mapping between the network's event data 302, associated network entity (e.g., network protocol, network equipment, network layer, network node, etc.) and network-specific metadata. In one implementation, the network-specific metadata signifies the type of network event and entity, e.g., a Bidirectional Forwarding Detection (BFD) session established between two routers. The metadata can further include information regarding network protocol (e.g., TCP), network location of the event (e.g., datacenter), security level associated with the event (e.g., public or private), traffic priority associated with the corresponding entity (e.g., medium), and the like. In one implementation, non-network specific metadata tags such as location, etc. are disregarded from the analysis.

In an implementation, infusing the event data of filtered events with network metadata tags enables accurate identification of network entities corresponding to each network event, and a relationship between the network event and the network entity. For example, when a Label Distribution Protocol (LDP) session is down (network event), based on mapping of information about the session with network-specific metadata, the system can identify important network information related to the event. For instance, the metadata identifies each Multiprotocol Label Switching (MPLS) router associated with the LDP session. These routers can be identified, in one example, by device identifiers linked to each router. The metadata can further identify a network layer of the network in which these routers are interconnected. For example, the routers can be associated with a session layer (e.g., layer L5 of network 180) of the network. Based on this information, the system creates a vector embedding representing the network event, such that the vector embedding represents all relevant network information associated with the network event. In doing so, the system also enables efficient correlation of the network event with other network events that are deemed “similar.” In one implementation, the system creates vector embeddings for each filtered network event, as shown in the figure (embeddings 308).

Based on the embeddings 308 created, the system generates correlated network events, e.g., based on a comparison of vector embeddings associated with each network event. In one example, each vector embedding from the embeddings 308 is compared with other embeddings to determine similar vector embeddings. This is depicted as embedding similarity check 312. In one implementation, the similarity can be determined using one or more techniques such as cosine similarity, Euclidean distance, Jaccard similarity index, and the like. In one implementation, similar vector embeddings identify correlated network events. In an implementation, system is configured to determine a threshold value above which vector correlations are considered similar or correlated. For example, the threshold can be set based on organizational domain knowledge, user-defined configurations, specific networks under surveillance, or other experimental specifics.

Next, the correlated network events are processed to generate an undirected network graph 320 depicting undirected relationships between correlated network events. In an implementation, the undirected network graph 320 is constructed using similar vector embeddings. In the graph 320, nodes represent vectors, and edges represent correlated relationships between the vectors. In an example, the undirected network graph 320 is a weighted graph where edge weights correspond to the strength of correlation. In an implementation, the undirected network graph 320 represents correlations between network events, however, without indicating the root cause of the network failure. Referring to the example above, when the LDP session is down, the undirected network graph 320 can provide other network events that occurred in temporal proximity of the LDP session failure. These network events could have occurred for different network entities interconnected in various layers of the network. Traditionally, network management systems would simply ascertain a root cause of network failure (i.e., in this case the root cause of LDP session being down) by analyzing correlated network events, and determining which network event occurred first, thereby marking that event as the root cause event. However, inaccuracy can result in such analysis because different network protocols may have different urgencies built in with respect to warnings and alarms. That is, some protocols may generate staggered alarms in the event of network failures, thus rendering timestamp based analysis inaccurate.

To accurately determine root cause of network events, the system is configured to further process the undirected network graph 320 by using a network-aware causation model (causation model 340). In an implementation, the causation model 340 operates based on outputs from a network hierarchy model, wherein the network hierarchy model is pretrained on different network hierarchies, as well as relationships between network events and network entities in each different network hierarchy. In one implementation, the causation model 340 uses outputs from the network hierarchy model, such that the causation model 340 can generate a logical order between correlated network events being processed, as occurring in different layers of a network. For instance, the logical order indicates which network events can occur in which order, irrespective of associated timestamps with each network event. For example, the logical order can indicate that a physical link event can cause a traffic loss and not vice-versa. Similarly, a BFD protocol failure can cause a LDP session to fail, but an LDP session cannot cause a BFD protocol flap. In another example, a change dictated by a user configuration of network events can trigger a sequential chain of down links, session failures, and/or traffic losses.

In an implementation, the causation model 340 processes the undirected network graph 320 using outputs from the pretrained hierarchy model (model 380). Based on the processing, the causation model is able to generate a directed network graph 385, such that the directed network graph 385 shows a first detected network event and one or more additional detected network events stemming from the first detected network event. In one or more implementations, the first detected network event is a probabilistic root cause of a given network failure. The directed network graph 385 provides an accurate prediction of root causes of network events, since the causation model 340 uses relationships identified between various correlated network events to different network entities to generate the directed network graph 385. In an implementation, the predictions (outputs) of the network hierarchy model 380 are used as features to train the causation model 340, therefore enabling training of the causation model 340 based on network interconnections of various entities within any given network as correlated to how network events occur in the network in light of these interconnections. Using this information as a training dataset, the causation model 340 can predict, with increasing accuracy, which network event caused other network events based on network event data directly received from the network. Further, the network hierarchy model 380 can also be continuously retrained using updated network hierarchies as well as new event types that an end-user can configure within the system. In one implementation, the model 380 can also be retrained based on policy data that, e.g., defining one or more events that can be disregarded from the analysis of network events. Continuously retraining the network hierarchy model 380 in turn updates the features of the causation model 340, resulting in the model 340 making increasingly accurate root cause predictions as they are gradually used by the network management system.

In the example shown in the figure, the directed graph 385 generated by the causation model 340 comprises of nodes N1-N6, depicting cause and effect relationships between each node. In an implementation, node N1 of the graph 385 represents a root cause of the network failure. Further, node N2 is an intermediate network event, from which more network events (represented by nodes N3-N6) stem. This way, network event of node N1 has a one-to-one intermediate relationship with network event of node N2, and one-to-one final relationships with network events of respective nodes N3-N6. In one implementation, the directed graph 385 is presented on a graphical user interface (GUI) of a requesting user device, e.g., in response to one or more user requests. The user device can be further provided with options to modify the presented graph 385, e.g., based on one or more user settings. These user settings can include preferences defined by the end-user, such that based on these settings selected network events can be highlighted for further analysis, disregarded from the root cause analysis, or event data for these events are otherwise modified. If such a preference is found associated with a user, the graph 385 can be updated in real-time. A specific non-limiting example of generating a directed network graph is further described with reference to FIG. 4.

FIG. 4 illustrates a block diagram of an example root cause analysis for network failures in an Open System Interconnection (OSI) based network. As depicted, a typical OSI network (network 402) comprises of seven layers, each responsible for specific tasks in facilitating communication between entities within the network 402. Layer 1 (L1) is a physical layer that deals with physical transmissions of data between various network entities (as shown). L1 defines specifications such as voltage levels, cable types, data rates, and physical connectors. Examples of network entities and associated protocols within this layer include Ethernet cables, fiber optics, Wi-Fi, and Ethernet switches. Layer 2 (L2) is a data link layer that provides transfer of data frames between nodes over a physical link. This layer deals with MAC (Media Access Control) addressing, frame synchronization, and flow control. Examples include Ethernet switches, MAC addresses, and protocols such as Ethernet and IEEE 802.11 (Wi-Fi). Layer 3 (L3) is a network layer responsible for routing packets from the source to the destination across multiple networks. It provides logical addressing and determines the best path for data transmission. This layer deals with IP addressing, routing, and logical network topologies. Example network entities for the layer include routers, IP addresses, and protocols such as IP (Internet Protocol), ICMP (Internet Control Message Protocol), and OSPF (Open Shortest Path First) protocol.

Layer 4, or transport layer, is used for transfer of data between end systems. It provides mechanisms for error detection, flow control, and data segmentation. Example protocols for the layer include TCP (Transmission Control Protocol) and UDP (User Datagram Protocol). Layer 5 (L5) is a session layer that establishes, manages, and terminates communication sessions between devices. It provides synchronization and dialog control between applications. This layer manages sessions such as login sessions, file transfer sessions, and web browsing sessions. Layer 6 (L6) is the presentation layer and is responsible for data translation, encryption, and compression. It ensures that data sent from the application layer of one system can be read by the application layer of another system. This layer deals with data format conversions, character encoding, and encryption/decryption. Finally, application Layer (L7) provides network services directly to end-users and applications. It enables communication between applications and provides network access to services such as email, file transfer, and web browsing.

In one or more implementations, network failures within the network 402 can occur due to one or more situations. This can include network congestion, device failure, physical layer issues, routing issues, environmental factors, and the like. In one implementation, a network management system managing the network 402 is configured to gather network event data (e.g., event data 404) for one or more network events happening at different layers for different entities interconnected within these layers. In the example shown, in the event data 404 gathered by the network management system, event data entries 404-1 and 404-2 are recorded for device D1, and event data entries 404-3 to 404-5 are recorded for device D2. In the example, the event data 404 for these events indicates that multiple BFD sessions have failed or malfunctioned for devices D1 and D2. Similarly, the event data 404 further indicates that interface failure (404-6 and 404-7) has occurred for devices D1 and D2. Further, an IS-IS (Intermediate System to Intermediate System) routing protocol failure (event data entry 404-8) is identified for device D1, two LDP failures (404-9 and 404-10) are identified for device D1, and two LDP failures (404-11 and 404-12) are identified for device D2. Finally, a packet loss anomaly (404-13) is also detected for the network 402.

The network management system translates various entries of the event data 404 gathered from the network 402 to generate correlated network events 406. In an implementation, the correlated network events are generated by first translating event data 404 into vector representations. These vector representations are then compared for similarity and similar vector representations are correlated to represent correlated network events 406 (as described in FIG. 3). In another implementation, the vector representations are created by augmenting event data 404 with network-specific metadata. For instance, the network metadata can indicate an association of network events with specific network layers and network entities. In the example described here, the BFD session events 404-1 and 404-2 can be linked with layer L2, e.g., between two routers R1 and R2, whereas interface failures can be linked with layer L1. Further, IS-IS routing protocol failure and LDP failures (e.g., between routers R3 and R4) are linked with layer L3. Finally, the packet loss anomaly is detected within layer L7. This information of relationship between various network entities and associated network events is indicated within correlated events 406. For instance, for each device D1 and D2, correlated events and their associated network information is generated as shown. For example, correlated event 406-1 indicates that two BFD sessions in the physical layer (L1) are malfunctioning for device D1. Another example of correlated events 406-2 shows that two LDP sessions in the network layer (L3) are malfunctioning for device D1. More correlated events 406-3 to 406-5 are similarly generated. Although not shown, similar correlated events can also be generated for device D2, e.g., based on event data 404 gathered for device D2.

In an implementation, the network management system processes the correlated events 406 using a causation model. As described in the foregoing, the causation model operates based on outputs from a pretrained network hierarchy model. In an implementation, the pretrained network hierarchy model is itself trained on different network hierarchies corresponding to various network types, e.g., network hierarchy of network 402, as well as previously gathered event data for each different network type. In one implementation, the causation model uses the outputs from the network hierarchy model, such that the causation model is able to predict a logical ordering of an occurrence of network events. For example, various events and/or outputs may be identifiable as corresponding to a given layer of a network. Based on the layers to which the data/events correspond, a logical ordering of their occurrence can be determined.

In one implementation, the logical order can be a sequential mapping of events, that indicates which network events occur in which order, irrespective of associated timestamps with each network event. For example, the mapping can indicate that a BFD protocol flap (e.g., event 404-1) can cause one or more LDP sessions to fail (events 404-9 and 404-10), but an LDP session cannot cause a BFD protocol flap. In another example, an interface down (event 404-6) can be a cause of a BFD flap (404-1), however, a vice-versa situation may not be possible. Such mappings may be available for all network events configured for the network 402.

In an implementation, the causation model processes the correlated events 406 to generate a directed network event graph 408, such that the network event graph 408 can identify a probabilistic root cause network event and one or more network events stemming from the root cause network event. As shown, node N1 of the graph 480 depicts that interface down (i.e., event 404-6) is a root cause of the other network events. For instance, event 404-6 causes an intermediate event represented by node N2 (i.e., BFD_down, event 404-1), from which more network events (represented by nodes N3-N6) originate. For instance, events 404-9 and 404-10 (represented by nodes N3 and N4) and events 404-8 and 404-13 (represented by nodes N5 and N6), stem from event 404-1 (Node N2). This way, the network event represented by node N1 (i.e., root cause event) can be determined as having a one-to-one intermediate relationship with network event of node N2 (stemming directly), and one-to-one final relationships with network events of respective nodes N3-N6 (stemming via node N2). Similar analysis can be performed for other devices, e.g., device D2 within the network 402. In one or more implementations, various network configurations can be analyzed using the implementations described herein. For example, the network 402 can include networks of various network topologies, which may consist of any combination of the following: bus, star, ring, mesh, star-bus, tree, hierarchical, and similar structures. The network 402 facilitates the exchange of data among distributed servers tasked with executing real-time root cause prediction.

Further, the implementations described herein provide network management systems an ability to automate root cause identification in a given set of anomalies and events. This analysis also helps in reduction of mean time to resolution (MTTR) of failures by providing quick and automated identification of the root causes of such failures. Further, the causation model also allows for user configurations to introduce new event types or adjust the network hierarchies for retraining the network hierarchy model. This allows the causation model to continuously adapt and thus can be reusable across multiple distinct deployments. Using the approaches disclosed herein, a large set of anomalies and events can be condensed into smaller sets of correlated events, and cause and effect relationships within that set of events are easily identified.

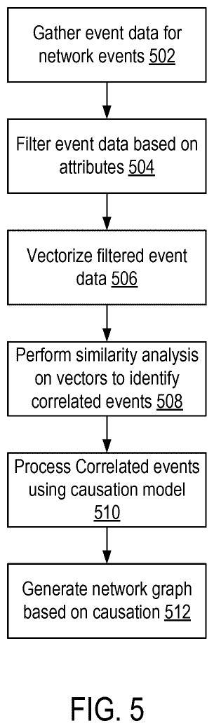

FIG. 5 illustrates a method for root cause analysis of a network failure in network-connected entities under surveillance.

As shown, the method starts with a network management system gathering event data for a plurality of network events (block 502). The event data includes information generated by network devices and systems regarding events or activities occurring within a computer network. This data includes details such as the timing, source, destination, type, and characteristics of network events, such as packet transmissions, connections, errors, or security incidents. Network event data is crucial for monitoring, troubleshooting, analyzing performance, detecting anomalies, and ensuring the security and reliability of the network under surveillance. In one or more implementations, the network events can be gathered for different time periods (e.g., based on user configurations and/or network analysis schedules) or in real-time as and when the data is generated. The data is gathered to analyze the data for performing a network fault prediction, e.g., based on a predicted root cause network events of the plurality of network events.

In one implementation, the data gathered is filtered based on attributes associated with the data (block 504). In an implementation, the event data is filtered based on filter criteria. For example, attributes of event data are compared with one or more filter criteria, so as to determine whether events corresponding to the event data can be grouped together. In various implementations, the attributes can include a preset time period window, recurring pattern thresholds, a sequence of event data arrival at the system, and the like. For example, if a given set of network events occur within a given time period dictated by the filter criteria (e.g., 5 minutes), these can be grouped together. In one example, the system disregards the order of the timestamps of individual event, and only considers the window of time to filter events. In another example, if a number of recurrences of two or more events exceeds a threshold number given by the filter criteria, these events can be grouped as well. Other implementations are contemplated.

The event data for the grouped filtered events are then vectorized (block 506). In an implementation, each vector represents event data for a particular network event. The vector representations are further embedded with network-specific metadata associated with each event. For instance, vector representations are embedded with operational context or metadata related to network behavior, performance metrics, configuration details, or other relevant operational aspects. This integration is performed to enable the vectors to capture the inherent structural relationships within the network as well as the network's dynamic operational characteristics. By using network metadata to create vector representations, the resulting vectors can be better analyzed based on an operational context of the network. In one example, the operational context is given by network-specific meta tags that signify the type of network event, e.g., a Bidirectional Forwarding Detection (BFD) session established between two routers for the purpose of monitoring the connectivity and forwarding path between them using the BFD protocol. In an implementation, other metadata tags such as location, etc. may be disregarded.

In one implementation, correlated network events are identified based on a similarity analysis performed on the vectorized event data (block 508). In one example, correlated network events are a set of network events that are statistically associated or linked in some manner (e.g., based on temporal proximity). These events demonstrate a relationship or dependency between them, indicating that the incidence of one event may influence or be influenced by the occurrence of another. Correlated network events are further analyzed to examine patterns or trends in network data to uncover relationships (e.g., cause and effect) between different events or variables. In an implementation, the similarity analysis is performed based on comparison of each vector representations with other vector representations in the set of event data vectors. In one or more examples, this similarity analysis can be performed based on Jaccard similarity index, cosine distance analysis, Euclidean distance analysis, or a combination thereof. When similar vectors are identified, network events corresponding to similar vector representations represent correlated network events.

The correlated events are further analyzed using a causation model (block 510). In one implementation, the causation model uses machine learning to identify and quantify causal relationships between events based on vector representations of event data. Unlike correlation, which only measures the strength of association between variables, the causation model is configured to identify the directionality and mechanisms underlying the relationships. The network events are processed with respect to various nodes identified in the causation model. The causation model then outputs a directional network event graph (block 512) that defines one-to-one relationships between a root network event and other network events stemming from the root network event.

In an implementation, to process the correlated events in light of network interconnections of various entities of the network under consideration, the causation model can be trained using outputs of another model, e.g., a pretrained network hierarchy model. In an implementation, the pretrained hierarchy model is originally trained based on network event data and network entities interconnected within various layers of a various networks. For example, the network hierarchy model is trained for analyzing, for a predetermined period of time and/or number of instances, event data for entities connected within these network. This analysis includes, without limitation, correlating the event data for each entity with different network layers of a network, as gathered from the network topology. That is, the network hierarchy model is not only trained on event data associated with network entities gathered over a period of time, but also on interconnections between different network entities operating within multiple layers of the network. Using outputs of the pretrained network-hierarchy model, the causation model can efficiently analyze network events in light of various network interconnections to perform root cause analysis for any given network.

In an implementation, the network event graph can be presented on a graphical user interface (GUI) of a requesting user device. Further options to modify the generated graph, e.g., based on one or more user settings can be provided. These user settings can include preferences defined by the end-user, such that based on these settings selected network events can be highlighted for further analysis, disregarded from the root cause analysis, or event data for these events are otherwise modified. If such a preference is found associated with a user, network graph can be updated in real-time.

In one or more implementations, root cause identification is the holy grail of any Artificial Intelligence Operations (AIOps) solution. An ability to automatically identify root causes of network failures can help users to save critical time, otherwise needed by engineers or administrative personnel to sift through volumes of network data. The present disclosure describes approaches that enable automatic pinpointing to the root cause of a network event, with a high degree of confidence. Further, the mean time to resolution (MTTR), which is a critical metric in network operations, is significantly reduced.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system configured to:
receive data corresponding to a detected network event;
identify one or more additional detected network events that correspond to a window of time that includes the detected network event; and
generate data that identifies an order in which the detected network event and one or more additional detected network events occurred, based at least in part on a relationship between each of the detected network event and the one or more additional detected network events to network entities.

2. The system as claimed in claim 1, wherein the system is further configured to generate, based at least in part on the generated data, a network event graph defining a one-to-one relationship between the detected network event and at least one additional detected network event from the one or more additional detected network events.

3. The system as claimed in claim 1, wherein the system is configured to modify the data that identifies the order, responsive to receiving, from a user device, an input indicating at least one modification to the relationship between each of the detected network event and the one or more additional detected network events to network entities.

4. The system as claimed in claim 1, wherein one of the detected network event and the one or more additional detected network events is indicative of at least one network error corresponding to a computing network.

5. The system as claimed in claim 1, wherein the system is configured to:
obtain, from a user device, a given user configuration representative of one or more network events different from each of the detected network event and the one or more additional detected network events; and
generate data that identifies an order in which the one or more network events occurred, based at least in part on a relationship between each of the one or more network events to network entities.

6. The system as claimed in claim 1, wherein the system is configured to:
generate a vector representation of each of the detected network event and the one or more additional detected network events; and
compare each vector representation with other vector representations to identify related network events.

7. The system as claimed in claim 1, wherein the window of time is selected based at least in part on one or more attributes corresponding to the detected network event, the one or more attributes at least comprising a temporal proximity parameter.

8. A method comprising:
receiving, by network management system, data corresponding to a detected network event;
identifying, by the network management system, one or more additional detected network events that correspond to a window of time that includes the detected network event; and
generating, by the network management system, data that identifies an order in which the detected network event and one or more additional detected network events occurred, based at least in part on a relationship between each of the detected network event and the one or more additional detected network events to network entities.

9. The method as claimed in claim 8, further comprising generating, by the network management system, based at least in part on the generated data, a network event graph defining a one-to-one relationship between the detected network event and at least one additional detected network event from the one or more additional detected network events.

10. The method as claimed in claim 8, further comprising modifying, by the network management system, the data that identifies the order, responsive to receiving, from a user device, an input indicating at least one modification to the relationship between each of the detected network event and the one or more additional detected network events to network entities.

11. The method as claimed in claim 8, wherein one of the detected network event and the one or more additional detected network events is indicative of at least one network error corresponding to a computing network.

12. The method as claimed in claim 8, further comprising:
obtaining, by the network management system from a user device, a given user configuration representative of one or more network events different from each of the detected network event and the one or more additional detected network events; and
generating, by the network management system, data that identifies an order in which the one or more network events occurred, based at least in part on a relationship between each of the one or more network events to network entities.

13. The method as claimed in claim 8, further comprising:
generating, by the network management system, a vector representation of each of the detected network event and the one or more additional detected network events; and
comparing, by the network management system, each vector representation with other vector representations to identify related network events.

14. The method as claimed in claim 8, wherein the window of time is selected based at least in part on one or more attributes corresponding to the detected network event, the one or more attributes at least comprising a temporal proximity parameter.

15. A network management system comprising:
data aggregator configured to:
receive data corresponding to a detected network event; and
data analyzer configured to:
identify one or more additional detected network events that correspond to a window of time that includes the detected network event; and
generate data that identifies an order in which the detected network event and one or more additional detected network events occurred, based at least in part on a relationship between each of the detected network event and the one or more additional detected network events to network entities.

16. The network management system as claimed in claim 15, wherein the data analyzer is further configured to generate, based at least in part on the generated data, a network event graph defining a one-to-one relationship between the detected network event and at least one additional detected network event from the one or more additional detected network events.

17. The network management system as claimed in claim 15, wherein the data analyzer is configured to modify the data that identifies the order, responsive to receiving, from a user device, an input indicating at least one modification to the relationship between each of the detected network event and the one or more additional detected network events to network entities.

18. The network management system as claimed in claim 15, wherein one of the detected network event and the one or more additional detected network events is indicative of at least one network error corresponding to a computing network.

19. The network management system as claimed in claim 15, wherein the data analyzer is configured to:
obtain, from a user device, a given user configuration representative of one or more network events different from each of the detected network event and the one or more additional detected network events; and
generate data that identifies an order in which the one or more network events occurred, based at least in part on a relationship between each of the one or more network events to network entities.

20. The network management system as claimed in claim 15, wherein the data analyzer is configured to:
generate a vector representation of each of the detected network event and the one or more additional detected network events; and
compare each vector representation with other vector representations to identify related network events.
